(19) United States
(12) Patent Application Publication
(10) Pub. No.: US 2011/0195259 A1
(43) Pub. Date: Aug. 11, 2011

(54) Metallizable and Metallized Polyolefin Films and a Process of Making Same

(76) Inventor: Kwangjin Song, Pittsford, NY (US)

(21) Appl. No.: 12/963,028

(22) Filed: Dec. 8, 2010

Related U.S. Application Data
(60) Provisional application No. 61/303,028, filed on Feb. 10, 2010.

(51) Int. Cl. C08K 5/544; C08L 83/04; C08K 5/5419; C08K 5/5435; C08L 23/10; B32B 9/00; B32B 27/06; B29C 47/06

(52) U.S. Cl. 428/447; 524/262; 525/106; 524/269; 524/265; 264/171.1

(57) ABSTRACT

Films that include at least one metallizable layer, wherein the metallizable layer includes a polyolefin and at least one organosilicon compound, such as silane, polysilane, side group modified polysilane, graft or block copolymer of silane, polycarbosilane, particularly organosilicon compounds having a silicon:(oxygen+nitrogen) molar ratio of 0.3 to 3.5 are described. Metallized films having good barrier properties and metal adhesion as well as methods for making such films are described.

### PRIORITY CLAIM

This application claims priority to and the benefit of U.S. Ser. No. 61/303,028, filed Feb. 10, 2010, the disclosure of which is incorporated herein by reference in its entirety.

### FIELD OF THE INVENTION

This invention relates to oriented films having a metallizable or metallized layer. The invention further relates to a process for the manufacture of these films, and to the use of these films as packaging products.

### BACKGROUND OF THE INVENTION

To improve barrier, the polyolefin packaging film is often deposited with metals, metal oxides, or inorganic and organic hybrid materials. Due to its hydrophobic surface; however, polyolefin film tends not to adhere well to these materials. To improve adhesion of the polyolefin film to such substrates, a hydrophilic modifier can be incorporated to promote interfacial adhesion between hydrophobic and hydrophilic substrates. Several such modifiers are known in the art.

For example, U.S. Pat. No. 5,698,317 discloses a metallizable polyolefin layer comprising petroleum resins and terpene resins. U.S. Pat. No. 6,420,041 (ExxonMobil, 2002) discloses a metallizable polyolefin skin comprising a compound having the formula of R—X, where R is an aliphatic hydrocarbyl group consisting of 20 to 200 carbon atoms and X is a hydrophilic group, such as —COOH or —CH₂OH.

U.S. Pat. No. 6,503,635 and U.S. Pat. No. 6,703,134, disclose a metallizable polyolefin layer that comprises a graft copolymer of propylene and maleic anhydride. U.S. Pat. No. 6,764,752 discloses a metallizable resin layer comprising a hydroxyl- or carboxyl-terminated polyethylene wax.

Still there remains a need for improving adhesion, particularly the adhesion of metals to polyolefin films without unacceptable effects on other properties such as oxygen transmission rate (OTR) and/or water vapor transmission rate (WVTR).

### SUMMARY OF THE INVENTION

In one aspect, embodiments of the invention provide a film comprising of at least one metallizable layer, wherein the metallizable layer comprises a polyolefin and at least one compound, wherein the organosilicon compound comprises at least one silane, polysilane, side group modified polysilane, graft or block copolymer of silane, polycarbosilane, or mixture thereof. In certain such embodiments, the organosilicon compound has the general formula of X(CH₂)₃Si(OR)₃ or [—SiRR′—]ₖ, wherein X is selected independently from the group comprising a functional or reactive substituent; OR is an alkoxy group; R and R′ are selected independently from a hydrogen atom, a hydrocarbon group, or a functional or reactive substituent; and k is an integer≧4.

In another aspect, embodiments of the invention provide a film that, when metallized, provides acceptable barrier properties and improved metal adhesion. Embodiments of such films comprise at least one metallizable layer, wherein the metallizable layer comprises a polymer, such as polyolefin (e.g., a polypropylene comprising 95 to 100 wt % of units derived from propylene monomer), and at least one organosilicon compound having a silicon: (oxygen+nitrogen) molar ratio of 0.3 to 3.5, particularly a molar ratio of from 0.5 to 1.5, wherein the silicon:(oxygen+nitrogen) molar ratio is based oxygen and nitrogen atoms bound to silicon.

In particular embodiments, the organosilicon compound is selected from the group consisting of polysilsesquioxanes, polyhedral oligomeric silsesquioxanes (POSS), polyhedral oligomeric silicates (POS), and mixtures thereof. Some suitable polyhedral oligomeric silicates (POS) follow one or more of the following general formulas: 1) [RSiO_{1.5}]ₙ, 2) [RSiO_{1.5}]ₙ[RXSiO_{1.0}]ₘ, or 3) [RSiO_{1.5}]ₙ[RSiO_{1.0}]ₘ[M]ⱼ, wherein

n, is an integer ranging from 1 to 100;

m is an integer ranging from 1 to 100; and

j is an integer ranging from 1 to 100;

each R is independently a hydrogen atom, a C₁ to C₂₀ alkyl group, a C₁ to C₂₀ aryl group, a C₁ to C₂₀ hydroxyalkyl group, a C₁ to C₂₀ amine, a C₁ to C₂₀ imide, a nitride, a C₁ to C₂₀ carboxylic acid, a C₁ to C₂₀ ester, a C₁ to C₂₀ acrylate, a C₁ to C₂₀ epoxide, a C₁ to C₂₀ ketone, a C₁ to C₂₀ olefin group, a C₁ to C₂₀ ether-containing group, or a halide.

Polyhedral oligomeric silsesquioxane or polyhedral oligomeric silicates may also be described by Formula (I), (II), or (III):

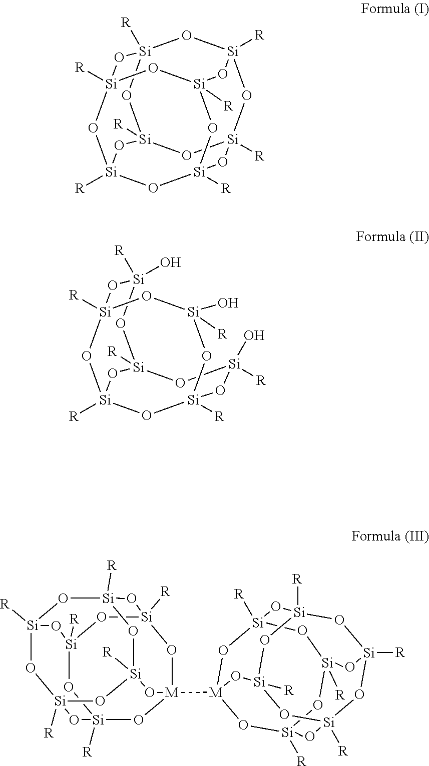

wherein each R is independently selected from a hydrogen atom; a halide; a substituted or unsubstituted, linear or branched C₁ to C₂₀ alkyl group; a substituted or unsubstituted, linear or branched C₁ to C₂₀ aryl group; a substituted or unsubstituted, linear or branched C₁ to C₂₀ amine, a substituted or unsubstituted, linear or branched C₁ to C₂₀ hydroxyalkyl; and wherein M is a metal atom, preferably aluminum or tin. In particular embodiments, each R is independently a methyl group, an ethyl group, a phenyl group, an isobutyl group, an isooctyl group, a cyclohexyl group, or a cyclopentyl group, more particularly each R is an isobutyl group or an isooctyl group.

Particular organosilicon compounds include polysiloxanes of the formula [—SiRR′O—]ₙ, wherein n is an integer≧3, R, R′ and R″ are independently selected from hydrogen, alkyl or aryl group, e.g., a polysiloxane selected from the group consisting of poly(dimethysiloxanes), ω-monofunctional poly(dimethysiloxanes), α,ω-difunctional poly(dimethysiloxanes), poly(di-n-propylsiloxane), poly(di-p-propylphenylsiloxane), poly(dimethysiloxanes)/polypropylene copolymers, polysiloxane/polypropylene copolymers, and poly(dimethysiloxanes)/ethylene vinyl alcohol copolymer (EVOH) copolymers.

Other organosilicon compounds include polysilazanes of the formula [—SiRR′NR″—]ₙ, wherein n is an integer≧1, R, R′ and R″ are independently selected from hydrogen, a C₁ to C₂₀ alkyl groups and C₁ to C₂₀ aryl groups.

In another aspect, embodiments of the invention provide a film wherein the organosilicon compound comprises at least one silane, polysilane, side group modified polysilane, graft or block copolymer of silane, or mixture thereof. In some such embodiments, the organosilicon compound has the general formula of X(CH₂)₃Si(OR)₃ or [—SiRR′—]ₖ, wherein X is selected independently from the group comprising a functional or reactive substituent; OR is an alkoxy group; R and R′ are selected independently from a hydrogen atom, a hydrocarbon group, or a functional or reactive substituent; and k is an integer≧4. Embodiments of the invention also include those wherein the organosilicon compound is a polysilane having alkoxy sidechains grafted thereon.

Particularly suitable functional or reactive substituents include those that are linear, cyclic, branched, or combinations thereof, e.g., a substituent including at least one functionality selected from the group comprising alcohol, amine, amide, imide, nitride, carboxylic acid, ester, acrylate, epoxide, ketone, olefin, ether, halide, acetate, peroxide, isocyanate, alkoxide, or combination thereof.

Some suitable exemplary silanes include γ-glycidoxytrimethoxysilane, vinyl silane, methacrylic silane, 3-mercaptopropyl trimethoxy silane, amino silane, poly(di-n-alkylsilane), poly(methyl-n-propylsilane), poly(hydroxyphenyl alkylsilane), poly[1-(6-methoxylhexyl)-1,2,2-trimethyldisilylene], poly(methylephenyle silane)-co-poly(ethylene oxide), or mixture thereof.

Some suitable organosilicon compounds may be particularly useful where they possess a boiling point≧100° C., preferably ≧200° C., measured according to ASTD D 1078-05 and/or a surface energy ranging from 15 to 50 dyne/cm², particularly 15 to 25 dyne/cm².

In some embodiments, the metallizable layer comprises from greater than 0 to ≦30 wt %, particularly ≧10 wt %, more particularly 10 to 1000 ppm, of the organosilicon compound, based on the weight of the metallizable layer.

While not wishing to be bound by any theory, it is believed that the organosilicon compound may provide a metallizable layer that includes smectic regions having a lamellar crystal thickness ranging from 5 to 20 nm.

In another aspect, the invention relates to metallized films having a metal layer, particularly an aluminum layer, formed on a metallizable layer that includes an organosilicon compound as described above having a metal layer in surface contact with the metallizable layer. Some metallized films have one or more of the following properties:
i) a haze value before metallization according to ASTM method D 1003 of <5%;
ii) a light transmission ratio before metallization according to ASTM method D 1003≧70%;
iii) an oxygen transmission rate (OTR)≦30 cc/m2/day according to ASTM D3985 at 23° C. and 0% relative humidity;
iv) a water vapor transmission rate (WVTR)≦0.3 g/m²/day according to ASTM F1249 at 37.8° C. and 90% relative humidity; and
v) a metal pick-off value of ≦10% and a crazing value of ≦10%.

In another aspect, embodiments of the invention provide a method for making the film of any preceding claim, comprising: (a) forming a mixture comprising a polyolefin and a organosilicon compound described above; and (b1) extruding the mixture to form a metallizable layer; or (b2) co-extruding said mixture with additional polymeric material to form a multilayer film. Some methods further include orienting the film wherein orienting the film includes a process selected from the group consisting of machine direction orientation, transverse direction orientation, simultaneous biaxial orientation, sequential biaxial orientation, single bubble orientation processes, double bubble processes, and combinations thereof.

### BRIEF DESCRIPTION OF THE DRAWINGS

FIG. 1 is schematic cross-section of metallizable, biaxially oriented, polypropylene multi-layer film according to an embodiment of the invention.

### DETAILED DESCRIPTION OF THE INVENTION

### Definitions

The term “polymer” as used herein, generally includes but is not limited to, homopolymers, copolymers (such as for example, block, graft, random and alternating copolymers), terpolymers, etc., and blends and modifications thereof. Furthermore, unless otherwise specifically limited, the term “polymer” shall include all possible geometrical configurations of the material. These configurations include, but are not limited to isotactic, syndiotactic, and random symmetries.

The term “polyolefin” as used herein, is intended to mean any of a series of largely saturated polymeric hydrocarbons, typically formed by catalytic polymerization of olefin monomers. Typical polyolefins include, but are not limited to, polyethylene, polypropylene, and various combinations copolymers formed form polymerization of olefin monomers e.g., ethylene, propylene, butenes, etc.

The term “polypropylene” as used herein is intended to encompass not only homopolymers of propylene, but also polymers wherein at least 85% of the recurring units are derived from propylene monomer, the remainder comprising units derived from one or more other olefin monomers.

The term “metallizable layer” means a layer intended to receive a metal layer and, expressly includes a layer in surface contact with a metal layer, i.e., a metallizable layer that has been metallized.

The term “density” is defined as the mass per unit volume and is usually expressed in units of g/cm³. Film density can be calculated from yield and optical gauge measurements using the following formula: Density (g/cm³)=1000/[yield (m²/kg)*optical gauge (μm)].

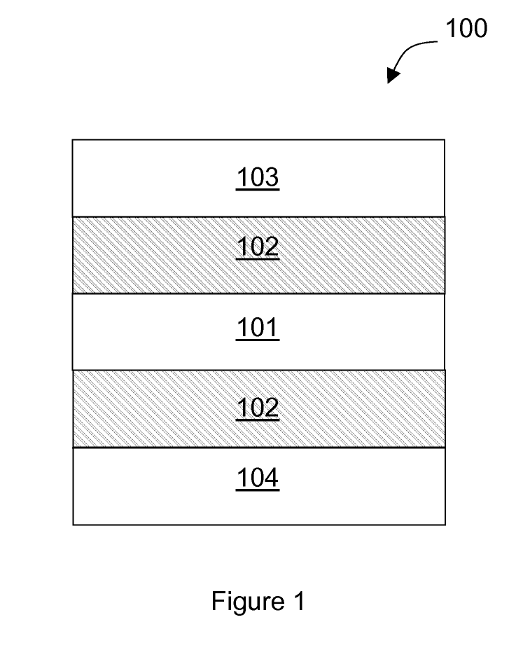

FIG. 1 depicts a film 100 comprising a core layer 101, independent optional tie layers 102, and a metallizable layer 103. A sealant skin layer 104 is also optional. Core layer 101 comprises a thermoplastic polymer which has properties suitable for extrusion or coextrusion followed by biaxial orientation in the machine and transverse directions under elevated temperature so as to form a multi-layer film. Any such thermoplastic polymer may be used, particularly polymers made from a 2 to 4 carbon atom olefin, such as ethylene, propylene, or butene-1. The preferred thermoplastic polymer of the core layer is a polymer made predominantly of propylene with minor amounts of one or more other olefins, usually a 2 to 4 carbon atom olefin. In some embodiments, the core layer 101 comprises a polypropylene homopolymer, preferably having at least 90 wt %, 92 wt %, 95 wt %, or 98 wt % of units derived from propylene monomers.

Optionally, the core layer may also include an antistatic agent in addition to the thermoplastic polymer. The antistatic agent is not critical and may be selected from any suitable antistatic agent, e.g., glycerol monostearate (GMS) and a blend of GMS and tertiary amine. Suitable amounts for the antistatic agent may range from about 0.05 wt % to about 3 wt %, based upon on the weight of the core layer.

In some embodiments, the core layer 101 is cavitated. Preferably, cavitated core layer includes polybutylene terephthalate; calcium carbonate; nylon; or preformed glass, metal, or ceramic spheres. In the case wherein polybutylene terephthalate is used, it is preferably present at a level of at most about 15 wt % of said core layer.

Where present, a tie layer 102 is positioned intermediate the core layer 101 and another film layer, such as for example the metallizable layer 103 or optional sealant layer 104. Tie layers 102 of a multi-layer film are commonly used to connect two layers that might otherwise not bond well due to incompatibility issues. The tie layer may also provide some other functionality, such as barrier enhancement, antiblock particle support, improved sealability, machinability, or other benefits, as desired. Thus, a tie layer 102 typically comprises a polyolefin composition, e.g., polypropylene, that is different from the layers it connects. But in other embodiments, a tie layer 102 may have substantially the same composition as the core layer 101, particularly due to extruder design, e.g., where a 5-layer extrusion die is used to provide a film 100 wherein the core layer 101 and two tie layers 102 are formed from the same polymer feed. In some embodiments, the tie layer 102 is in direct contact with a surface of the core layer. In other embodiments, another layer or layers may be intermediate the core layer 101 and the tie layer 102 described herein.

Metallizable layers 103 of the invention include a thermoplastic polymer such as those suitable for the core layer 101 and at least one suitable organosilicon compound. The preferred thermoplastic polymer of the metallizable layer 103 is a polymer made predominantly of propylene, optionally with minor amounts of one or more other olefins, usually a 2 to 4 carbon atom olefin. In some embodiments, the metallizable layer 103 comprises a polypropylene polymer, preferably having at least 90 wt %, 92 wt %, 95 wt %, or 98 wt % of units derived from propylene monomers, particularly a polypropylene homopolymer.

Some suitable organosilicon compounds possess a repeating unit having at least one carbon moiety, oxygen atom, nitrogen atom, functional or reactive substituent, or combination thereof. In particular embodiments, the organosilicon compound has a silicon:(oxygen+nitrogen) molar ratio of 0.3 to 3.5, based on the number of oxygen and nitrogen atoms bound to silicon. In other words, the ratio of the moles of silicon atoms in the organosilicon compound to the sum of the moles of oxygen atoms and nitrogen atoms that are bound to silicon atoms ranges from 0.3 to 3.5. In particular embodiment, the silicon:(oxygen+nitrogen) molar ratio is 0.5 to 1.5, or 0.75 to 1.0. Typically 0 wt % to ≦30 wt %, preferably ≦10 wt % (based on the weight of the metallizable layer), of the organosilicon compound is present in the metallizable layer. The synthesis process and properties of some such organosilicon compounds are disclosed by Jones et al, Silicon-Containing Polymers, Kluwer, Dordrecht (2000) and Zeigler et al, Silicon-Based Polymer Science, ACS, Washington (1990).

Some suitable organosilicon compounds include polysiloxanes [—SiRR′O—]ₙ, polysilazanes [—SiRR′NR″—]ₙ, organosilicon dendrimers, and combinations thereof. Here, n is an integer≧1. R, R′ and R″ are a hydrogen atom, alkyl or aryl group, from which each R, R′ and R″ are selected independently.

Organosilicon compounds may be either silicon-functional, i.e., a functional group is directly attached to the silicon atom, or organofunctional, i.e., a functional group is tethered through alkylene or arylene group. The polymers disclosed herein include homopolymers, copolymers, terpolymers, or combinations thereof, which comprise functional or reactive substitutions as a pendant group, branch, graft or block. The term “nanostructured” hereafter represents the diameter of a single entangled molecule to be in the range from 0.5 nm to 500 nm.

### Polysilsesquioxanes

In certain embodiments, the organosilicon compound is a polysilsesquioxane e.g., a nanostructured polysilsesquioxane, including silsesquioxanes, polyhedral oligomeric silsesquioxanes (POSS) and polyhedral oligomeric silicates (POS) that can be described by one of the general formulas: [RSiO_{1.5}]ₙ, [RSiO_{1.5}]ₙ[RXSiO_{1.0}]ₘ, and [RSiO_{1.5}]ₙ[RSiO_{1.0}]ₘ[M]ⱼ. Here, n, m and j represent an integer in the range from 1 to 100, preferably 1 to 30. R is a to hydrogen atom or a carbon moiety, from which each R is selected independently and is selected from another POSS, POS, an alkyl or aryl group that itself may have functional substituents such as alcohols, amines, imides, nitrides, carboxylic acids, esters, acrylates, epoxides, ketones, olefins, ethers, halides, etc. X is selected from amide (—CONR₂), amine (—NR₂), acetate (—OOCR), peroxide (—OOR), isocyanate (—NCO), alkoxide (—OR), —OLi, —ONa, —OK, —OH, —Cl, etc. M is a metal element.

The polysilsesquioxanes may have a variety of structures including, for example, random structures, ladder structures, branched ladder structures, partial cage structures, cage structures, bridged structures, or combinations thereof. Polysilsesquioxanes may be prepared by standard techniques or processes using silicon bearing hydrolytically stable organic substituents and three easily hydrolyzed groups that are reacted with water in the presence of acid or base catalysts. The reactions involve hydrolysis to form silanols and their condensation to form siloxane bonds.

For example, U.S. Pat. No. 5,412,053 discloses a process for preparing polysilsesquioxanes containing alternating silsesquioxane and bridging group segments. U.S. Pat. No. 5,484,876 discloses a process for preparing reactive POSS and polysilsesquioxanes. U.S. Pat. No. 5,939,576 discloses a selective synthesis process for POSS and POS that employs metal catalyzed hydrosilyation reactions with olefinic reagents.

Suitable examples of silsesquioxane polymers include poly(methylsilsequioxane), poly(phenysilsequioxane), poly(methyl-co-phenysilsequioxane), with and without functional substitutions. Suitable examples of POSS and POS can be obtained from commercial sources such as Hybrid Plastics, Inc. (Hattiesburg, Miss.), which include 1,2-propanediolisobutyl POSS®, aminopropylisooctyl POSS®, aminoethyl aminopropyl isobutyl POSS®, amic acid-isobutyl POSS®, triglycidylisobutyl POSS®, chloropropylisobutyl POSS®, methacrylate Isooctyl POSS®, methacryl POSS®, Isooctyl POSS®, isooctylpheny POSS®, octaisobutyl POSS®, octamethyl POSS®, octatrimethylsiloxy POSS®, cyanopropylisobutyl POSS®, trinorbornenylisobutyl POSS®, mllylisobutyl POSS®, monovinylisobutyl POSS®, octavinyl POSS®, PEG POSS®, octasilane POSS®, trisilanolcyclohexyl POSS®, trisilanolethyl POSS®, trisilanolisobutyl POSS®, trisilanolisoctyl POSS®, trisilanolphenyl POSS®, tetrasilanolphenyl POSS®, mercaptopropylisooctyl POSS®, Aluminum POMS®, Tin POMS®, etc. Other suitable silsesquioxane polymers are described in U.S. Pat. Nos. 7,491,783 and 7,485,692.

### Polysiloxanes

In some embodiments, the organosilicon compound is a homopolymer or copolymer of siloxane with a general formula [—SiRR′—]ₙ, where n is an integer≧1; and R and R′ are selected independently from a hydrogen atom, a hydrocarbon group, or a substituted hydrocarbon group with alcohols, amines, imides, nitrides, carboxylic acids, esters, acrylates, epoxides, ketones, olefins, ethers, halides, etc. Preferred are polysiloxanes having functional substitutions including, for example, side group modified polysiloxanes, is graft or block copolymers of siloxane, and combinations thereof. Polysiloxanes may be produced, for example, as disclosed in U.S. Pat. Nos. 5,075,479; 5,491,249; and 5,395,956.

Side-group modified polysiloxanes may be produced by polycondensation of bifunctional monomers, hydrosilylation of siloxane polymers, and ring-open polymerization of functional cyclosiloxanes. Block or graft copolymers of siloxane may be prepared from ω-monofunctional or α,ω-bifunctional polysiloxanes.

Suitable examples of polyosiloxanes include poly(dimethysiloxanes, PDMS), ω-monofunctional PDMS, α,ω-difunctional PDMS, poly(di-n-propylsiloxane), poly(di-p-propylphenylsiloxane), polysiloxanes modified in side groups by acrylic, vinyl, epoxy, styrenic, mesogenic groups, etc., block and graft copolymers of PDMS and polypropylene, block and graft copolymers of polysiloxane and polypropylene, block and graft copolymers of polysiloxane with functional substitutions and polypropylene, block and graft copolymer of PDMS and ethylene vinyl alcohol copolymer (EVOH), block and graft copolymer of polysiloxane with functional substitutions and EVOH, etc. Preferred are polysiloxanes having functional substitutions. Siloxane polymers are commercially available from Dow Corning Corp. (Midland, Mich.), Shin-Etsu Chemical Co. (Tokyo, Japan), etc.

### Silanes and Polysilanes

In other embodiments, the organosilicon compound of the metallizable layer 103 comprises of at least one silane, polysilane, side group modified polysilane, graft or block copolymer of silane, a polycarbosilane of the formula [—SiRR′CR″—]ₙ, or mixture thereof. In one embodiment, the organosilicon compound is a silane having a general structure of X(CH₂)₃Si(OR)₃, polysilanes having a general structure of [—SiRR′—]ₙ, or combinations thereof, where, n is an integer≧4; X represents an organofunctional group to bond or coupled to an organic matrix phase, including, for example, vinyl, allyl, amino, epoxy, mercapto, methacryloxy, cyclohexenyl, etc.; OR is a hydrolysable group such as methoxy, ethoxy, acetoxy, etc.; and R and R′ are a hydrogen atom, alkyl or aryl group, from which each R and R′ are selected independently.

Suitable examples include vinyl silanes, methacrylic silanes, 3-mercaptopropyl trimethoxy silanes, amino silanes, poly(di-n-alkylsilanes), poly(methyl-n-propylsilanes), poly(hydroxyphenyl)methylsilanes, etc. Preferred silanes have a boiling point≧100° C. and more preferably ≧200° C., measured according to ASTD D 1078-05.

Preferred polysilanes have alkyl or aryl group that comprises functional or reactive substituents, such as, for example, alcohols, amines, imides, nitrides, carboxylic acids, esters, acrylates, epoxides, ketones, olefins, ethers, halides, or mixtures thereof.

In one or more embodiments, a film according to embodiments of the invention further comprises at least one additional layer disposed on an outermost surface of any, polymeric layer. Such at least one additional layer includes, but is not limited to, a skin layer, a heat sealing layer, a laminatable layer, a printable layer and combinations thereof. In some embodiments, such any additional layer comprises a polymeric material. In other embodiments, such additional layers comprise papers, vacuum-deposited metals, foils, coatings or a combination thereof. Such coatings include protective coatings, heat sealing coatings, laminatable coatings, adhesive coatings, primer coatings, printable coatings or a combination thereof.

The polymeric resin used in the additional layer(s) is not particularly limited. In one or more embodiments, the additional layer(s) comprises any suitable polymeric material. Such polymeric material may comprise a homopolymer, a copolymer, a terpolymer or a blend of a C₂ to C₈ alpha-olefin, a polyamide, a polyacetate, a polyester, a polycarbonate, a polystyrene, a poly(vinyl chloride), a poly(ethylene vinyl alcohol), a poly(vinyl alcohol), a poly(ethylene vinyl acetate), a poly(acrylic acid) or a poly(ethylene terephthalate). In other embodiments, such additional layer(s) may be a polymeric material blended with polypropylene.

### Orientation

The multi-layer film may be oriented by one or more conventional film orientation processes known in the art. Such film orientation processes include, but are not limited to, blown film processes, tenter frame processes, LISIM™ (e.g., simultaneous machine and transverse direction orientation), single bubble processes, double bubble processes and combinations thereof. In one or more embodiments, the non-opaque single and multi-layer films of this invention may be monoaxially-oriented, or biaxially oriented. In some embodiments, such films may not be oriented. If the case of mono-axial orientation, the film is at least monoaxially-oriented in a machine direction or a transverse direction. In the case of biaxial-orientation, the film is biaxially-oriented in a machine direction and a transverse direction, either sequentially or simultaneously. For sequential orientation, the film is oriented in the machine direction and then in the transverse direction, or it is oriented first in the transverse direction and then in the machine direction. For simultaneous orientation, the film is oriented in the machine direction and the transverse direction simultaneously.

An exemplary process for manufacturing the inventive multi-layer polyolefin film includes the steps of co-extrusion of polymer melts through a film forming die, casting of the co-extrudates, biaxial stretching of the cast sheets, relaxation of the biaxially oriented film, surface treatment of the metallizable layer, and metallization on the treated surface of the multi layer film.

The multilayer film is co-extruded at temperatures≦280° C. The co-extruded sheets are quenched at a cooling rate≦50° C./s, measured by the temperatures of the sheet surfaces before and after cooling and the residence time of the cooling process. The cooling may be conducted with a chill roll and/or a water bath. The crystalline structure of quenched cast sheets is disclosed in detail by Piccarolo, J. Macromol. Sci., B31, 501 (1992) and Zia et al, Polymer, 47, 8163 (2006).

The cast sheet is then stretched at least uniaxially and preferably biaxially in the machine direction (MD) by 4.5 to 8.0 times at temperatures (T_{MDO})≦140° C. and in the transverse direction (TD) by 5 to 10 times. The temperatures of TD preheat and stretch (T_{TDO}) are in the range of 175° C. to 185° C., preferably the preheat zone temperatures are in the range of 171° C. to 175° C. and the stretch zone temperatures are in the range of 163° C. to 170° C. A relaxation ratio (c) in the TD is ≦5%.

Without being bound to any theory, it is believed that the manufacturing process of this invention produces a film having a metallizable layer possessing a smectic-like crystalline texture that is defined to consist of an unusually large population of poor crystals and highly oriented non-crystalline tie chains interconnecting poor crystals. The thickness of the lamellar crystal in the structure is typically in the range of 5 to 20 nm, disclosed by Rettenberger et al, Rheo. Acta. 41, 332 (2002) and Qiu et al, Polymer, 48, 6934 (2007). To a great surprise, it is uncovered that the smectic-like texture of the inventive film is highly elastic in microscopic scale, substantially mesomorphic and stable under surface treatment conditions, which therefore enables the film to have improved adhesion and barrier properties.

### Surface Treatment Process

The multilayer film is surface-treated on one or both of its outer surfaces under atmosphere or vacuum. The surface treatment may be conducted during or after orientation, e.g., for example, in a metallization chamber, by any method including corona, flame, plasma or combinations thereof. Preferred are low pressure plasma treatment and its combinations with flame or atmospheric plasma treatment.

The surface of the metallizable layer may be treated under the atmosphere by exposure to corona, flame, or plasma while the film is continuously passing between spaced electrodes or in close proximity with the stable flame cones. The intensity of the treatment is set to impart to a surface tension level≧35 dynes/cm in accordance with ASTM D 2578-84. Known corona treatment procedures contemplated herein are, for example, any of those disclosed in U.S. Pat. Nos. 3,255,099 and 4,297,187; EP Patent No. 1,125,972; and by Villermet et, Surface and Coatings Technology, 174-175, 899 (2003). Known flame treatment procedures are, for example, any of those disclosed in U.S. Pat. Nos. 3,255,099; 4,297,187; 3,028,622; 3,255,034; 3,347,697; and 4,239,827.

The low pressure plasma treatment may use an evacuable reaction chamber that is capable of maintaining treatment conditions, i.e., pressure, a flow rate of gases, power voltage, formation of plasma species, a deposition rate, etc. The multilayer films to be treated may be placed in or passed through the evacuable chamber. The intensity of the treatment is set to impart to a surface tension level≧35 dynes/cm in accordance with ASTM D 2578-84.

A premixed flame may use air or oxygen-enriched air as an oxidizer and a gaseous hydrocarbon as a fuel. Typical hydrocarbon fuels include natural gas, methane, ethane, propane, butane, ethylene, hydrogen, liquefied petroleum gas, acetylene, or blends thereof. Flames may be fuel-lean, stoichiometrically balanced, or fuel-rich.

Suitable examples of corona gases, components of a flame fuel mixture and plasma gases comprise noble, inert, oxidizing, reducing, or reactive monomeric or oligomeric gases in various combinations and ratios, for examples, such as helium (He), argon (Ar), nitrogen (N₂), oxygen (O₂), hydrogen (H₂), ethylene (C₂H₂), hydrogen peroxide (H₂O₂), water (H₂O), ammonia (NH₃), carbon dioxide (CO₂), nitrous oxide (N₂O), hydrogen sulfide (H₂S), air, silanes, siloxanes, or mixtures thereof. In one embodiment, the gas combination is a mixture of noble or inert gases with oxidizing or reducing gases in various ratios. In certain embodiments, the gas combination is a mixture of noble or inert gases with oxidizing gases and silanes or siloxanes in various ratios.

### Metallization

The treated surface of the metallizable layer of a multilayer film according to the present invention is metallized via the application thereto of a thin layer of metal. The treated surface may be metallized by vacuum deposition, or any other metallization technique, such as electroplating or sputtering. In one embodiment, the metal is aluminum, or any other metal capable of being vacuum deposited, electroplated, or sputtered, such as, for example, gold, zinc, copper, or silver. Typically, a metal layer is applied to an optical density (OD) of from 1.5 to 5.0 or preferably from 1.8 to 4.0, in accordance with the standard procedure of ANSI/NAPM IT2.19.

In certain embodiments, the metal is metal oxide, any other inorganic materials, or organically modified inorganic materials, which are capable of being vacuum deposited, electroplated or sputtered, such as, for example, SiOₓ, AlOₓ, SnOₓ, ZnOₓ, IrOₓ, organically modified ceramics “ormocer”, etc. Here an integer x is 1 or 2. The thickness of the deposited layer is typically in the range from 100 to 5,000 Å or preferably from 300 to 3000 Å.

### Test Procedures

Crystalline Melting Temperature (Tₘ): Tₘ of the polymer is measured according to ASTD D3418 with Differential Scanning calorimeter (DSC, Perkin Elmer Pyris 1 Thermal Analysis System). A polymer sample of 15 to 20 mg, equilibrated to 25° C., is heated beyond its Tₘ and then cooled to 25° C. at a rate of 10° C./min. The sample is allowed to equilibrate for 3 minutes and then reheated again beyond its Tₘ at a rate of 10° C./min. The melting temperature is defined as the point where, during the second melting of the sample, the peak endothermic heat flow required to maintain the heating rate of 10° C./min is observed.

Film Haze and Light Transmittance: Haze and light transmittance are respectively the percentage of incident light that is blocked by and passes through a film, and measured according to ASTM D 1003 with BKY-Garner XL-211 haze-gard plus hazemeters.

Oxygen transmission rate (OTR) is measured by using a Mocon Oxtran 2/20 unit in accordance with ASTM D3985 at 23° C. and 0% relative humidity (RH), and moisture vapor transmission rate (WVTR) by using a Mocon Permatran 3/31 unit in accordance with ASTM F1249 at 38° C. and 90% RH.

Optical Density (OD) is measured using a Tobias Associates model TBX transmission densitometer and Macheth Model TD903 and TD932, according to ANSI/NAPM IT2.19. The densitometer is set to zero with no film specimen. A film specimen is placed over the aperture plate of the densitometer with the test surface facing upwards. The probe arm is pressed down and the resulting optical density value is recorded.

Surface Tension of the metallizable layer is measured in accordance with ASTM D 2578-84. A series of liquids of different surface tensions are wiped over different regions is of the film surface. The surface tension of the metallizable layer is approximated by the surface tension of the liquid that just wetted the layer surface. The untreated surface of polypropylene had a test value of about 30 dyne/cm.

Metal Pickoff is measured by removing a strip of 1-inch wide 3M 610 tape adhered to the metallized surface of a multilayer film. The amount of metal removed is rated as follows:

$$\% Amount = \frac{Area that metal was picked off}{Total surface area of the sample taped} \times 100$$

A metal pick-off rating of 1 is assigned where the amount of metal removed is ≦5%. A metal pick-off rating of 2 is assigned where the amount of metal removed is 6-10%. A metal pick-off rating of 3 is assigned where the amount of metal removed is 11-20%. Metal pick-off ratings 4 and 5 correspond to 21-50%, and ≧51% metal removed, respectively. Metal pick-off ratings of 1 and 2 are preferred.

Extrusion Lamination and Crazing Resistance: The metallized layer of the film is extrusion laminated by low density polyethylene (Chevron 1017 LDPE) at 320° C. to an 18 μm BOPP film substrate. The weight of the LDPE melt is 10 lb/rm. The metallized film is run off the secondary unwind at a tension of 10.5 lb and the 18 μm BOPP film substrate off the primary unwind. The level of crazing resistance is measured by evaluating the amount of crazes produced by the extrusion lamination as follow:

$$\% Amount = \frac{\begin{matrix}Total surface area of the portion \\ that metal was crazed\end{matrix}}{Total surface area of the sample} \times 100$$

The scale 1.0 is ≦5% crazes produced, scale 2.0=6-10% crazes produced, scale 3.0=11-20% crazes produced, scale 4.0=21-50% crazes produced, and scale 5.0≧51% crazes produced. Scales 1 or 2 are preferred.

The present invention will be further described with reference to the following nonlimiting examples.

### Examples (Ex) 1 to 5

Film Extrusion: A 5 layer cast sheet is co-extruded at 250° C. with 5 separate extruders having a total output of about 500 lb/hour to 230 kg/hour. The co-extrudates are quenched with a chill roll and a water bath, both set to 20° C. The cast sheets are subsequently biaxially stretched 5.0 times in the MD using the combination of slow and fast speed rollers and 9.5 times in the TD with the tenter frame; and then relaxed in the TD at a ratio of 2.0% by the preset width of the tenter frame rails. The metallizable layer is in-line treated to surface energy≧35 dyne/cm by flame that is supported by a fuel mixture is composing of 90 mole % of dry air and 10 mole % of natural gas.

Metallization: The flame treated surface of the metallizable layer is treated again to surface energy≧35 dyne/cm inside the treatment chamber under a pressure of about 5×10⁻² mbar. The plasma gas is a mixture of 80/20% Ar/CO₂ at a flow rate of 550 standard cubic centimeters per minute (sccm). The treated web is then metallized with aluminum to an optical density of about 2.5 at a line speed of 350 m/min. The temperature of the process reel is set to about −20° C. The pressure in the metallization chamber is about 5×10⁻⁴ mbar. The metallized reel is taken out of the metallizer, unwound and slit.

Film Structure and Properties: The polymers and film layer structure of Example 1 are shown respectively in Tables 1 and 2. A metallizable skin is prepared by the pellet blend of 80 wt % PP4712 and 20 wt % of a master batch of MS0825; the tie and core layers are PP4612; and, a sealant skin is XPM7794. For Examples 2 to 5, the procedure of Example 1 is substantially repeated except that the metallizable layer had a different concentration of MS0825 in the range of 0.5 wt % to 5.0 wt %.

Table 3 shows the formulations of the metallizable skins and the measured properties of the Examples, wherein the crazing test is conducted with the laminated metallized films. The Example films had low haze, no metal pickoff, low OTR and WVTR, and no crazing during or after the extrusion lamination.

TABLE 1
Polymers Used in the Examples

| | | Property | | |
|---|---|---|---|---|
| | | Tₘ | MFI | |
| Name | Composition | (° C.) | (g/10 min) | Make |
| PP4612 | Homo Polypropylene (iPP) | 162 | 2.8 | ExxonMobil |
| PP4712 | Mini-random 0.5% Ethylene-PP (mrPP) | 162 | 2.8 | |
| HCPP 3270 | iPP | 165 | 2.0 | Total |
| MS0825 | Octaisobutyl POSS | 270 | / | Hybrid |
| SO1450 | Trisilanolisobutyl POSS | 270 | / | Plastics |
| SO1455 | Trisilanolisooctyl POSS | 270 | / | |
| MB25 | 50/50% co-PP/Ultra High MW Polysiloxane | 145 | 10 | Dow Corning |
| | terminated with —OH group | | | |
| XPM7753 | 1.2 wt % PDMS in Ethylene- | 122 | 5.0 | JPP |
| | propylene-butene terpolymer | | | |
| Z-6040 | γ-glycidoxytrimethoxysilane | 290 | / | Dow Corning |
| XM6030A | High Density PE (HDPE) | 130 | 2.0* | Equistar Lyondell |
| TD908BF | Ethylene-Propylene-Butene | 148 | 7.5 | Borealis |
| | Terpolymer (EPB) | | | |
| RC1601 | Propylene-Butene Copolymer (PB) | 150 | 7.0 | Basell |
| XPM7794 | Ethylene-propylene-butene | 122 | 5.0 | JPP |
| | terpolymer (EPB) | | | |

*MFI is measured at 190° C. and 2.15 kg

TABLE 2
Representative Structure of 5 Layer Example Films

| | Composition | | Thickness |
|---|---|---|---|
| Layer | (wt %) | Polymer Resin | (μm) |
| Metallizable Skin | 99.7/0.3% | PP4712/MS0825 | 1.0 |
| Tie | 100 | PP4612 | 3.0 |
| Core | 100 | PP4612 | 10.0 |
| Tie | 100 | PP4612 | 3.0 |
| Sealant Skin | 100 | XPM7794 | 1.0 |

TABLE 3
Metallizable Skins and Measured Properties of the Examples and Comparative Examples

| | | | Film | Metallized Film | | | Laminated Film | |
|---|---|---|---|---|---|---|---|---|
| | Metallizable Skin | | Haze†† | Pick | OTR | WVTR | OTR | Crazing |
| Film | Component-1 | Component-2 | (%) | Off | (cc/m²/d) | (g/m²/d) | (cc/m²/d) | Rate |
| Ex 1 | 0.3 wt % MS0825 | 99.7% PP4712 | 1.01 | 1 | 21.9 | 0.10 | 21.48 | 1 |
| Ex 2 | 0.5 wt % MS0825 | 99.5% PP4712 | 0.90 | 1 | 19.4 | 0.11 | 20.61 | 1 |
| Ex 3 | 1.0 wt % MS0825 | 99.0% PP4712 | 1.10 | 1 | 18.4 | 0.12 | 21.19 | 1 |
| Ex 4 | 2.0 wt % MS0825 | 98.0% PP4712 | 1.01 | 1 | 16.7 | 0.09 | 15.73 | 1 |
| Ex 5 | 5.0 wt % MS0825 | 95.0% PP4712 | 1.10 | 1 | 15.1 | 0.09 | 16.01 | 1 |
| Ex 6 | 0.3 wt % SO1450 | 99.7% PP4612 | 1.05 | 1 | 15.1 | 0.09 | 14.43 | 1 |
| Ex 7 | 0.3 wt % SO1455 | 99.7% PP4612 | 1.06 | 1 | 14.7 | 0.10 | 13.50 | 1 |
| Ex 8 | 0.3 wt % SO1455 | 99.7% | 1.05 | 1 | 14.1 | 0.09 | 15.02 | 1 |
| | | HCPP3270 | | | | | | |
| Ex 9 | 2.0 wt % MB25 | 98.0 wt % | 1.10 | 1 | 15.0 | 0.08 | 14.20 | 1 |
| | | PP4612 | | | | | | |
| Ex 10 | 20 wt % XPM7753 | 80% PP4612 | 1.15 | 1 | 19.4 | 0.11 | 17.65 | 1 |
| Ex 11 | 0.1 wt % Z-6040 | 99.9% PP4612 | 1.10 | 1 | 16.2 | 0.10 | 15.12 | 1 |
| Cx 1 | XM6030A | / | 1.50 | 1 | 25.1 | 0.21 | 28.5 | 5 |
| Cx 2 | TD908BF | / | 1.60 | 1 | 11.5 | 0.14 | 31.2 | 5 |
| Cx 3 | RC1601 | | 1.61 | 1 | 12.6 | 0.12 | 35.2 | 5 |
| Cx 4 | PP4712 | / | 1.01 | 5 | 47.1 | 0.80 | 51.14 | 1 |
| Cx 5 | PP4612 | / | 1.05 | 5 | 52.2 | 0.91 | 59.61 | 1 |
| Cx 6 | Total 3270 | / | 1.10 | 5 | 45.6 | 0.74 | 42.56 | 1 |

††Film Haze determined on unmetallized film.

### Examples (Ex) 6 to 11

The procedure of Example 1 is substantially repeated except that the metallizable layer comprised a different organosilicon compound. Table 3 shows the formulations of the metallizable skins and the measured properties of the Examples. The Example films had low haze, no metal pickoff, low OTR and WVTR, and no crazing during or after the extrusion lamination.

### Comparative Examples (Cx) 1 to 6

The procedure of Example 1 is substantially repeated except for the metallizable layers in the absence of any organosilicon compound. Table 3 shows the formulations of the metallizable skins and the measured properties of the Comparative Examples. The comparative samples had either poor crazing resistance or poor metal adhesion with the rate of scale 5.

As demonstrated in the various Examples and Comparative Examples above, the multilayer polyolefin films of the instant invention exhibited excellent adhesion and barrier properties, i.e., little or no metal pickoff, high barrier, little or no crazing, and little or no OTR degradation after the extrusion lamination.

While the invention has been described in detail and with reference to specific embodiments thereof, it will be apparent to one of ordinary skill in the art that various changes and modifications can be made therein without departing from the spirit and scope of the invention. The Examples recited herein are demonstrative only and are not meant to be limiting.

What is claimed is:

1. A film, comprising of at least one metallizable layer, wherein the metallizable layer comprises a polymer, such as polyolefin, and at least one organosilicon compound, wherein the organosilicon compound is characterized by a silicon:(oxygen+nitrogen) molar ratio of 0.3 to 3.5, wherein the silicon:(oxygen+nitrogen) molar ratio is based on oxygen and nitrogen atoms bound to silicon.

2. The film of claim 1, wherein organosilicon compound is selected from the group consisting of grafted-polysilanes, polysiloxanes, and mixtures thereof, wherein the molar to ratio ranges form 0.5 to 1.5.

3. The film of claim 1, wherein organosilicon compound is selected from the group consisting of polysilsesquioxanes, polyhedral oligomeric silsesquioxanes (POSS), polyhedral oligomeric silicates (POS), and mixtures thereof.

4. The film of claim 3, wherein the organosilicon compound comprises a polyhedral oligomeric silicates (POS) of one or more of the following general formulas: 1) [RSiO_{1.5}]ₙ, 2) [RSiO_{1.5}]ₙ[RXSiO_{1.0}]ₘ, or 3) [RSiO_{1.5}]ₙ[RSiO_{1.0}]ₘ[M]ⱼ, wherein:
n, is an integer ranging from 1 to 100;
m is an integer ranging from 1 to 100;
j is an integer ranging from 1 to 100;
each R is independently a hydrogen atom, C₁ to C₂₀ alkyl group or C₁ to C₂₀ aryl group, C₁ to C₂₀ hydroxyalkyl group, a C₁ to C₂₀ amine, C₁ to C₂₀ imide, a nitride, a C₁ to C₂₀ carboxylic acid, a C₁ to C₂₀ ester, a C₁ to C₂₀ acrylate, a C₁ to C₂₀ epoxide, a C₁ to C₂₀ ketone, a C₁ to C₂₀ olefin group, C₁ to C₂₀, an ether-containing group, or a halide;
X is independently selected from the group consisting of an amide group, an amine, an acetate, an organoperoxide, an isocyanate, alkoxide, —OLi, —ONa, —OK, —OH, and halides; and
M is a metal element.

5. The film of claim 3, wherein the polyhedral oligomeric silsesquioxane or polyhedral oligomeric silicate follows Formula (I), (II), or (III): 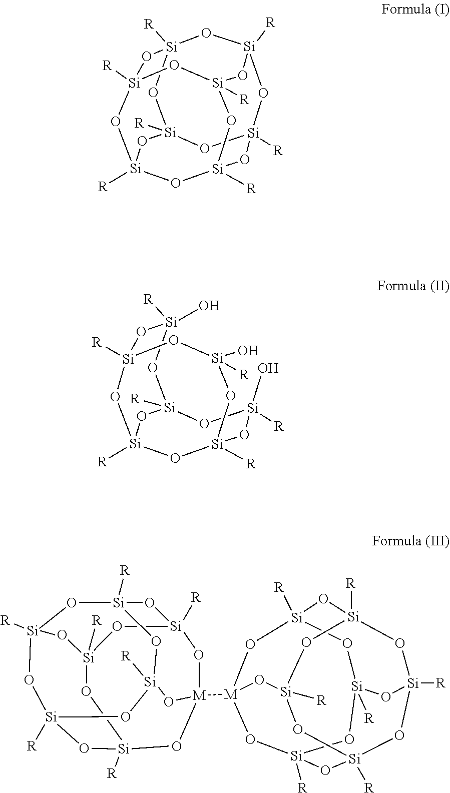
wherein each R is independently selected from hydrogen, halides, substituted or unsubstituted, linear or branched C₁ to C₂₀ alkyl groups or substituted or unsubstituted, linear or branched C₁ to C₂₀ aryl group, substituted or unsubstituted, linear or branched C₁ to C₂₀ amines, substituted or unsubstituted, linear or branched C₁ to C₂₀ hydroxyalkyls; and wherein M is a metal atom, preferably aluminum or tin.

6. The film of claim 5, wherein each R is independently a methyl group, an ethyl group, a phenyl group, an isobutyl group, an isooctyl group, a cyclohexyl group, or a cyclopentyl group.

7. The film of claim 6, wherein each R is an isobutyl group or an isooctyl group.

8. The film of claim 1, wherein the organosilicon compound is polysilane having alkoxy sidechains grafted thereon.

9. The film of claim 1, wherein the organosilicon compound has a boiling point≧100° C., is preferably ≧200° C., measured according to ASTD D 1078-05.

10. The film of claim 1, wherein the organosilicon compound comprises a polysiloxane [—SiRR′O—]ₙ, wherein n is an integer≧3, R, R′ and R″ are independently selected from hydrogen, alkyl or aryl group.

11. The film of claim 10, wherein the organosilicon compound comprises a polysiloxane selected from the group consisting of poly(dimethysiloxanes), ω-monofunctional poly(dimethysiloxanes), α,ω-difunctional poly(dimethysiloxanes), poly(di-n-propylsiloxane), poly(di-p-propylphenylsiloxane), poly(dimethysiloxanes)/polypropylene copolymers, polysiloxane/polypropylene copolymers, poly(dimethysiloxanes)/ethylene vinyl alcohol copolymer (EVOH) copolymers.

12. The film of claim 1, wherein the organosilicon compound comprises a polysilazane [—SiRR′NR″—]ₙ, wherein n is an integer≧1, R, R′ and R″ are independently selected from hydrogen, C₁ to C₂₀ alkyl group or C₁ to C₂₀ aryl group.

13. The film of claim 1, wherein the organosilicon compound has a surface energy ranging from 15 to 50, more particularly 15 to 25, dyne/cm².

14. The film of claim 1, wherein the metallizable layer comprises ≦30 wt % organosilicon compound, based on the weight of the metallizable layer.

15. The film of claim 1, wherein the metallizable layer comprises ≦10 wt % organosilicon is compound, based on the weight of the metallizable layer.

16. The film of claim 1, wherein the metallizable layer comprises 10 to 1000 ppm of at least one organosilicon compound, based on the weight of the metallizable layer.

17. The film of claim 1, wherein the metallizable layer includes smectic regions having a lamellar crystal thickness ranging from 5 to 20 nm.

18. The film of claim 1 having a metal layer in surface contact with the metallizable layer.

19. A method for making the film of claim 1, comprising:
(a) forming a mixture comprising a polyolefin and a organosilicon compound, wherein the organosilicon compound is characterized by a silicon:(oxygen+nitrogen) molar ratio of 0.3 to 3.5, wherein the silicon:(oxygen+nitrogen) molar ratio is based on oxygen and nitrogen atoms bound to silicon; and
(b1) extruding the mixture to form a metallizable layer; or
(b2) co-extruding said mixture with additional polymeric material to form a multilayer film.

20. A multilayer film, comprising:
a polypropylene core layer having a first side and a second side;
a metallizable layer on a first side of the core layer comprising a 60 to 99 wt % polypropylene homopolymer or copolymer and 1 to 30 wt % organosilicon compound (based on the total weight of the metallizable layer), wherein the organosilicon compound is characterized by a silicon:(oxygen+nitrogen) molar ratio of 0.3 to 3.5;
a polyolefin skin layer on a second side of the core layer; and
optionally a metal layer in surface contact with the metallizable layer;
wherein the silicon:(oxygen+nitrogen) molar ratio is based on oxygen and nitrogen atoms bound to silicon; the core layer optionally including one or more polypropylene homopolymer or copolymer tie layers in surface contact with the metallizable layer and/or the skin layer.
